(19) United States
(12) Patent Application Publication
(10) Pub. No.: US 2011/0050407 A1
(43) Pub. Date: Mar. 3, 2011

(54) SOBRIETY INTERLOCK DEVICE

(76) Inventors: Alexander Schoenfeld, Herzliya Pituach (IL); Yaki Nesher, Tel Aviv (IL)

(21) Appl. No.: 12/810,309

(22) PCT Filed: Dec. 24, 2008
(86) PCT No.: PCT/IL08/01664

§ 371 Date: Sep. 20, 2010

Related U.S. Application Data
(60) Provisional application No. 61/016,828, filed on Dec. 27, 2007.

(51) Int. Cl. B60R 25/00

(52) U.S. Cl. 340/426.11

(57) ABSTRACT

A device and method for measuring the alcohol concentration in a driver's saliva is used in an automobile ignition locking system. The device includes an input testing unit, a processing unit, and an output unit. The input testing unit includes a sampling device, an analyzing unit, and a housing unit. The analyzing device consists a socket for inserting the saliva sample and a contact image sensor for capturing and recording the resulting image. The recorded image is transferred to the processing unit that includes an A/D converter, a digital logic processor, and an ignition system controller. The A/D converter converts the image into digital values, and the digital logic processor processes the data and generates test results. The digital logic processor disables the ignition system controller, which disables the ignition system when the alcohol level is higher than the threshold value. The output unit displays test results and instructions for the user.

### FIELD OF THE INVENTION

The present invention relates to devices and methods for determining the blood alcohol concentration of a driver, and more specifically, to a device and method for measuring the alcohol concentration in a driver's saliva, thus providing a sobriety interlock for vehicle ignition.

### BACKGROUND OF THE INVENTION

Automobile driving by intoxicated persons is a serious problem responsible for accidents involved with injuries, deaths and property damage.

Various attempts have been made in the past to develop methods and devices that prevent automobiles from being operated by drunk drivers. Some typical methods and devices proposed in the past are described herein.

U.S. Pat. No. 3,823,382 to Gaddy discloses a system in which a sample of the driver's breath is directed to a chamber containing chemical granules, which react with alcohol fumes exothermally. The heat generated by the reaction is detected by a temperature responsive switch, which is connected in a control circuit and serves to energize an alarm and timing means in response to actuation of the temperature responsive switch. After a predetermined time interval, the timing means actuates a second alarm and initiates the operation of a second timing means. The second timing means after a predetermined time interval serves to actuate a relay, which opens the ignition circuit of the motor vehicle effectively preventing operation of the motor vehicle by an inebriated driver.

U.S. Pat. No. 6,853,956 to Ballard, Jr. et al discloses a sobriety interlock system having an alcohol detection device electrically connected to a computing device. A breath sample is provided by an operator of the machine, and the alcohol detection device determines the alcohol concentration of the breath sample. The device prevents or allows operation of the machine based on the level of the blood alcohol concentration.

U.S. Pat. Application No. 0127145 to Der Ghazarian et al discloses a RF breathalyzer system, which transmits a unique RF signal in response to a toxic or non-toxic breath sample given to the RF breathalyzer by the user. An immobilizer CPU is installed in a vehicle to receive commands from the RF breathalyzer and to control the vehicle horn, lights, and immobilize the engine.

U.S. Pat. No. 6,792,793 to Mendoza describes a breath measurement instrument using a combination of breath pressure, temperature, and humidity measurements to determine whether or not breath samples are human and properly delivered. Also disclosed is a breath alcohol instrument having an alcohol-specific fuel cell and a fuel cell circuit for generating a breath alcohol signal. Further disclosed is an interlock system for inhibiting operation of machinery such as a vehicle, and a method for screening breath samples and determining an alcohol content thereof.

U.S. Pat. No. 6,205,840 to Thompson discloses a time clock breathalyzer for determining the amount of alcohol in an air flow. The device includes a controller adapted to calculate an alcohol percentage amount within a user from the amount of alcohol detected by the alcohol sensor. The controller is further adapted to provide an indication upon the alcohol percentage amount being greater than a predetermined amount.

Other breath measurement instruments are disclosed in:

U.S. Pat. No. 3,186,508 to Lamont

U.S. Pat. No. 4,093,945 to Collier et al.

U.S. Pat. Application No. 2002/0084130 to Der Ghazarian et al.

U.S. Pat. Application No. 2002/0089660 to Weiss

PCT No. WO 01/12457 to Flores

U.S. Pat. No. 5,426,415 to Prachar et al.

U.S. Pat. No. 4,592,443 to Simon

U.S. Pat. No. 4,697,666 to Collier et al.

U.S. Pat. No. 6,853,956 to Ballard, Jr. et al.

Kr Pat Application No. 2,070,659 to Park

Kr Pat Application No. 3,096,147 to Park

Kr Pat Application No. 1,019,558 to Yoo

AU Pat Application No. 3,626,684 to Drummond & Rugis

ES Pat Application No. 2,150,398 to Hernandez et al.

CA Pat Application No. 2,463,201 to Stock

A different type of an ignition interlock device is disclosed in U.S. Pat. No. 6,229,908 to Edmonds, III, et al. This patent describes a method and an ignition interlock for preventing operation of equipment when an operator's blood-alcohol content is above a threshold value. The interlock has a blood-alcohol detector that measures intensities of wavelengths of light emerging through a finger to detect the alcohol concentration in the blood.

Other methods and devices used for preventing a driver under the influence of alcohol from operating a vehicle are disclosed in:

PCT No. WO 2004/078511 to Nordin

PCT No. WO 2005/118326 to Karlsson

PCT No. WO2005/026477 to Onishi et al.

PCT No. WO 2005/028788

As described above, various schemes for determining a person's blood alcohol concentration exist nowadays. However, since the schemes are all involved with some inconveniency, none of them has gained widespread use. Moreover, none of the existing schemes proposes direct measurements of alcohol concentration in a person's body fluids, and thus, they are not highly accurate. Breath analyzers, for instance, allow for avoidance of accurate tests as breath tests require a deep lung breath sample, and thus, can be evaded by inhaling and exhaling repetitively. Similarly, analyzers, which measure and relate intensities of wavelengths of light emerging through a person's finger to the blood-alcohol content, tend to be inaccurate as well.

Therefore, an aim of the present invention is to disclose a relatively simple and non-expensive ignition interlock scheme, which acquires direct blood-alcohol measurements that are not affected by environmental factors.

### SUMMARY OF THE INVENTION

Accordingly, it is a principal object of the present invention to overcome the disadvantages of existing ignition interlock devices and provide a relatively simple and non-expensive ignition interlock device, which acquires accurate blood-alcohol measurements.

In accordance with a preferred embodiment of the present invention, there is provided a sobriety interlock device for measuring the alcohol concentration in a driver's saliva sample and prohibiting ignition of a vehicle when the driver is intoxicated, said device comprising:

a testing unit into which a saliva sample of the driver is insertable for testing and recording the alcohol concentration in said saliva sample;

a processing unit for receiving said recorded sample results and providing test results;

an ignition system controller responsive to said test results to enable or disable the vehicle ignition system when the test passes or fails respectively; and

an output unit for displaying said test results and providing instructions and messages.

The testing unit of the inventive interlock device comprises a sampling device for collecting saliva, an analyzing unit for analyzing the saliva sample, and a housing tube for storing the analyzing unit.

The processing unit of the device comprises an A/D converter for converting analog data to digital data, a digital logic processor for processing the data, and an ignition system controller for controlling (i.e., enabling or disabling) the ignition system.

In accordance with a preferred embodiment of the present invention, the sobriety interlock device is integrated with a face recognition system for determining if the driver is a person allowed to operate the automobile.

The identity test results are transferred into the processing unit, which based on the results of both the sobriety test and the identity test either enables or disables the ignition system.

Other features and advantages of the present invention will become more readily apparent and understood from the detailed description section that follows.

### BRIEF DESCRIPTION OF THE DRAWINGS

For a better understanding of the invention with regard to the embodiments thereof, reference is made to the accompanying drawings, in which like numerals designate corresponding elements or sections throughout and in which:

FIG. 1a is a block diagram illustrating a preferred embodiment of a saliva analyzer sobriety interlock device constructed and operated in accordance with the principles of the present invention;

FIG. 1b is a block diagram illustrating a face recognition system integrated with the inventive saliva analyzer sobriety interlock device;

FIG. 2a illustrates a side-view of a testing unit used in the inventive saliva analyzer sobriety interlock device;

FIG. 2b illustrates a magnified-view of the sampling device and the analyzing unit used in the inventive saliva analyzer sobriety interlock device in accordance with a preferred embodiment of the present invention illustrated in FIG. 2a;

FIG. 3a illustrates a testing unit used in the inventive saliva analyzer sobriety interlock device in accordance with an alternative embodiment of the present invention;

FIG. 3b illustrates a magnified-view of the sampling device and analyzing unit used in the saliva analyzer sobriety interlock device in accordance with the alternative embodiment of the present invention illustrated in FIG. 3a;

FIG. 4 is a perspective view of a vehicle interior including a saliva sobriety interlock device; and

FIG. 5 is a side view of the vehicle interior illustrating interior parts of the saliva analyzer sobriety interlock device;

### DETAILED DESCRIPTION OF THE PREFERRED EMBODIMENTS

The ignition interlock scheme, in accordance with a preferred embodiment of the present invention, is aimed at measuring alcohol concentrations in a person's saliva.

Such measurements reach a greater level of accuracy than prior art breath measurements simply because the relationship between the blood alcohol and the amount of saliva alcohol is about 1:1 while the relationship between blood alcohol and breath is 1:0.00048.

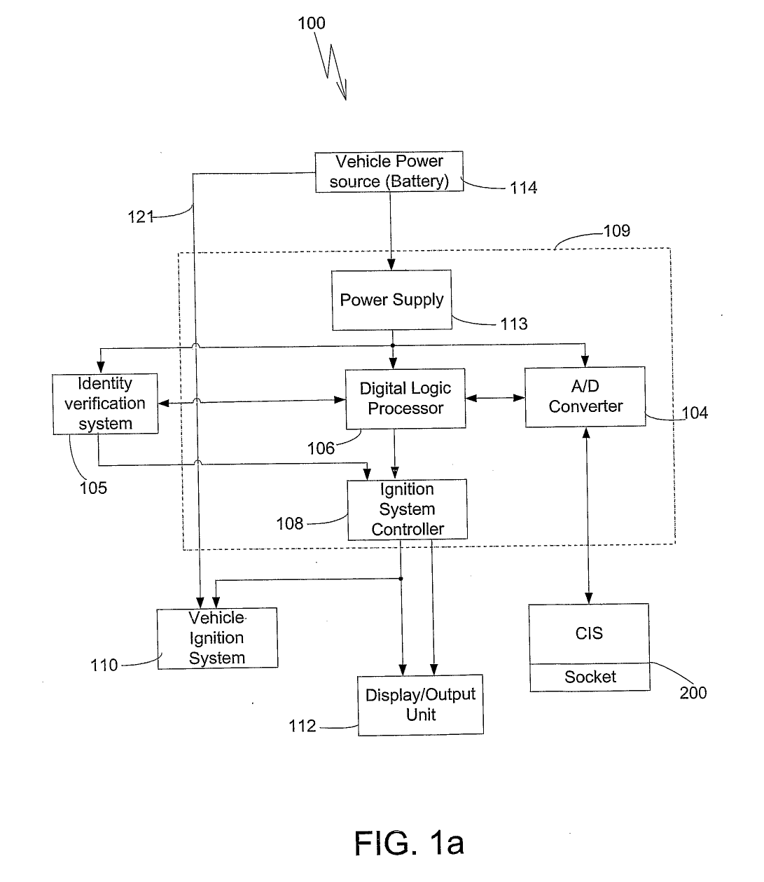

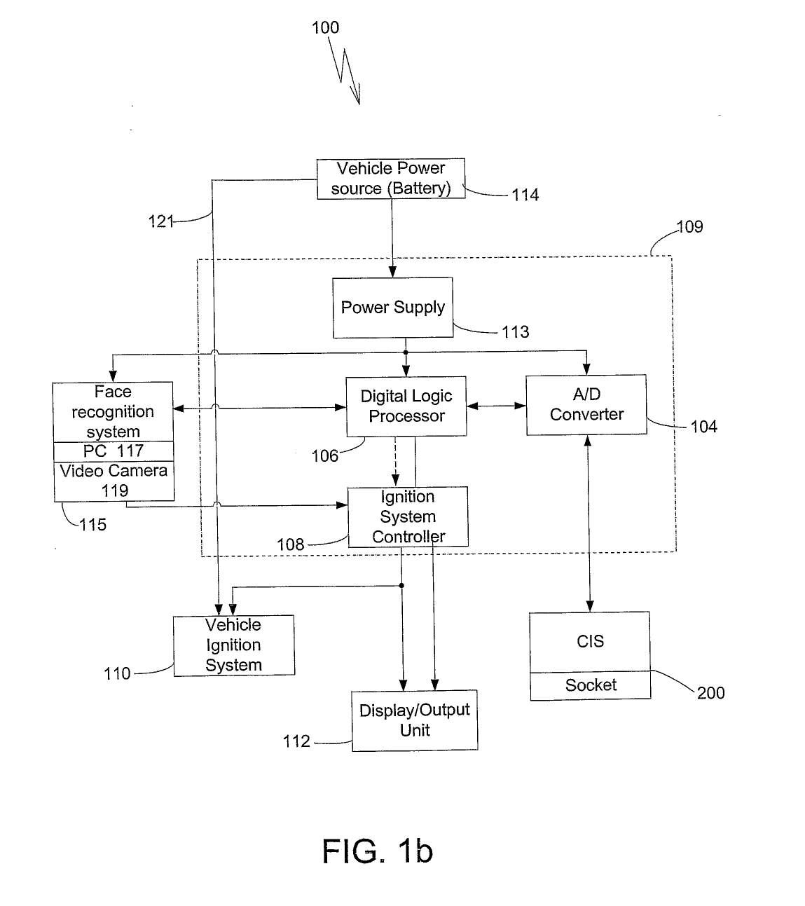

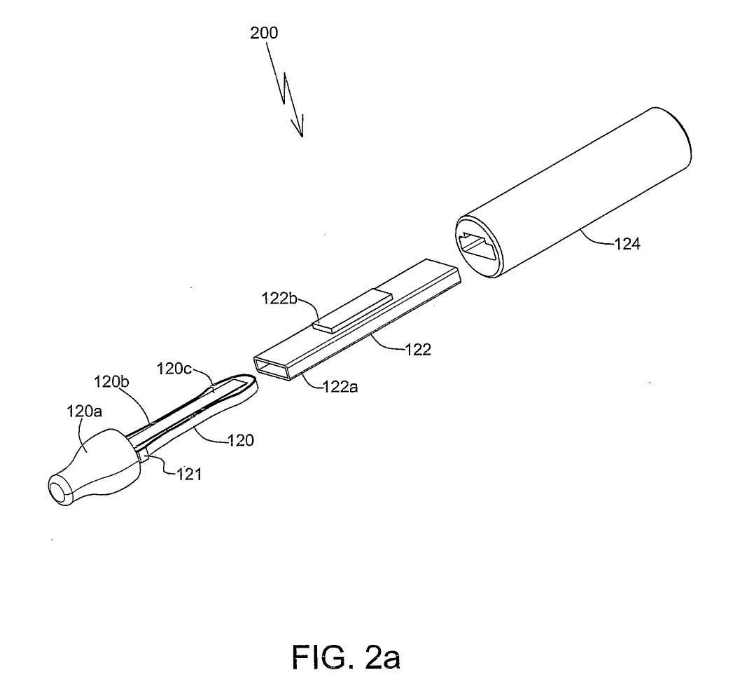

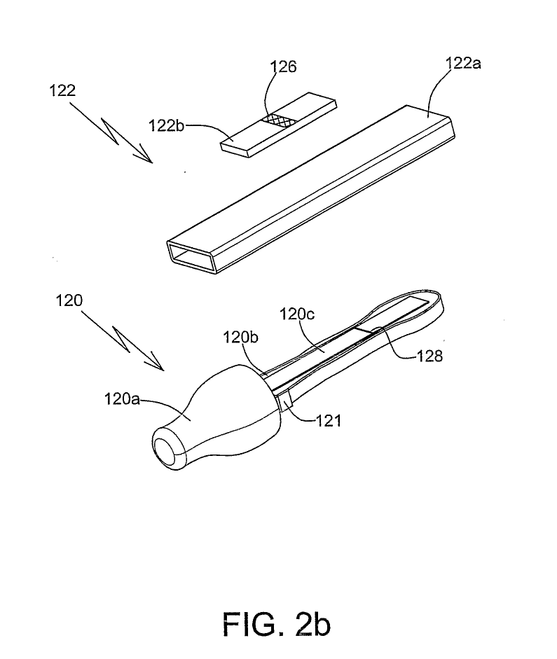

FIG. 1a is a block diagram illustrating a preferred embodiment of a saliva analyzer sobriety interlock device 100 constructed and operated in accordance with the principles of the present invention. The saliva analyzer sobriety interlock device 100 comprises testing unit 200 for obtaining a saliva sample (see FIG. 2a), processing unit 109 for performing an sobriety test, output unit 112 (i.e., a graphic user interface—GUI controller) for displaying test results, and identity verification system 105 for verifying the identity of the user. The output of the processing unit 109 is fed to vehicle ignition system 110.

According to a preferred embodiment of the present invention, one begins a sobriety test by inserting a reagent pad 120c (see FIG. 2a) into an analyzing unit 122 (see FIG. 2a) to initiate the testing procedure. Reagent pad 120c is then removed from analyzing unit 122 and inserted into the driver's mouth for some predetermined time for collecting saliva. When reagent pad 120c is completely saturated with saliva, it is re-inserted into analyzing unit 122 (see FIG. 2a) for determining and recording the alcohol level, and the recorded data is transferred into processing unit 109 for comparing the alcohol level to a threshold value stored internally.

Further details of the system construction and operation are now presented by reference to the remaining figures.

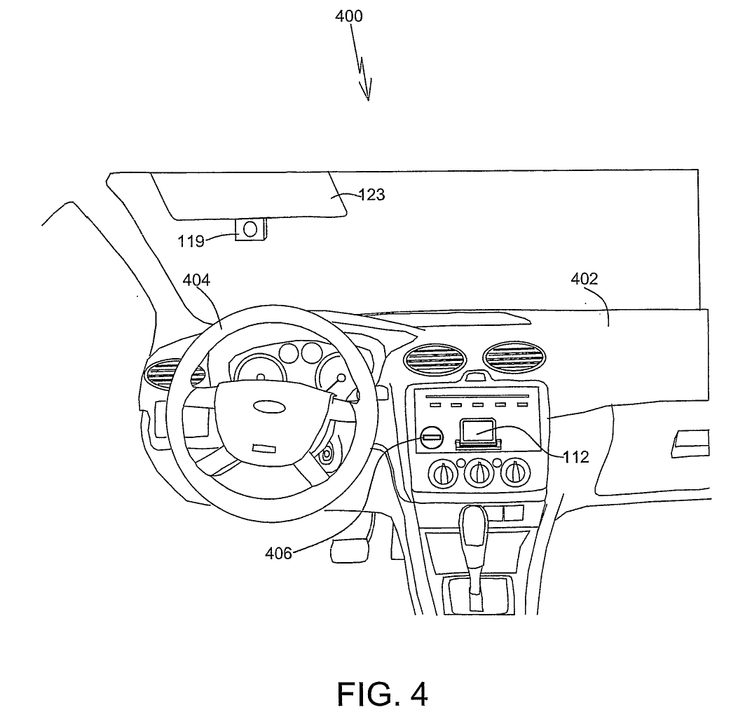

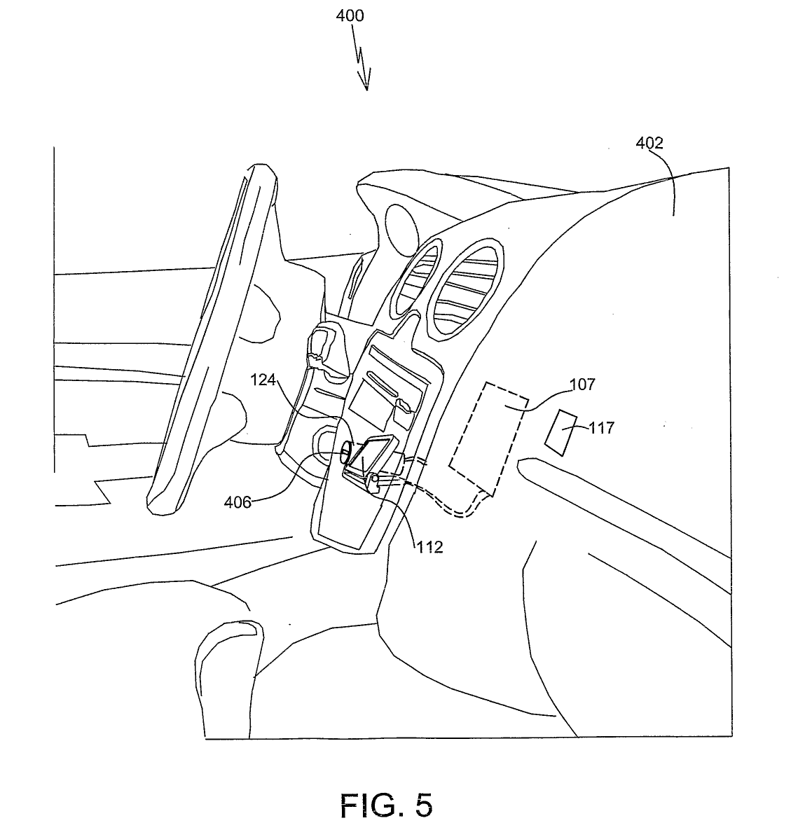

FIG. 1b is a block diagram illustrating saliva analyzer sobriety interlock device 100 with a specific example of the identity verification system in accordance with a preferred embodiment of the present invention. In this embodiment, a face recognition system 115 such as the commercially available “Face Snap Recorder” manufactured by Crossmatch Technologies (Palm Beach Gardens, Fla.) is utilized. Face recognition system 115 includes PC 117 and video camera 119. PC 117 is mounted underneath dashboard 402 along with other components of the device (see FIG. 5) and video camera 119 is attached to sun visor 123 (see FIG. 4). Operational details of face recognition system 115 are further described herein.

As seen in the figure, processing unit 109 comprises A/D converter 104 for converting analog data into digital data, digital logic processor 106 for processing the data, and ignition system controller 108 for controlling (i.e., enabling or disabling) ignition system 110. In addition, I/O cables are used for transferring data among the various components of saliva analyzer sobriety interlock device 100 (i.e., among testing unit 200, processing unit 109, face recognition system 115, and output unit 112), and power cables are used for transferring electric power from vehicle power source 114 to power supply 113 and to the various components (i.e., testing unit 200, processing unit 109, face recognition system 115, and output unit 112) of saliva analyzer sobriety interlock device 100.

Typically, the components of saliva analyzer sobriety interlock device 100 are designed to use five volts provided from power supply 113 which draws power directly from the twelve-volt car battery 114; therefore, saliva analyzer sobriety interlock device 100 operates regardless of whether the key switch of the car is on or off. In addition, a backup battery is installed in the device in order to allow functioning when the car power is off or out of order.

FIG. 2a illustrates a side-view of testing unit 200 used in saliva analyzer sobriety interlock device 100. As seen, testing unit 200 comprises sampling device 120 for collecting saliva, analyzing unit 122 for analyzing the saliva sample, and housing tube 124 for storing analyzing unit 122.

Sampling device 120 comprises handle 120a to be grasped by one hand of the user. Extending from handle 120a is flat medium 120b on top of which there is placed reagent pad 120c, such as a disposable reagent pad manufactured by Expomed Inc. (Munroe Fralls Ohio).

As seen in the figure, flat medium 120b comprises side-protrusion 121 to insure an interlock when inserted into socket 122a (flat medium 120b has to be inserted all the way into socket 122a to activate saliva analyzer sobriety interlock device 100).

Analyzing unit 122 comprises transparent socket 122a, into which flat medium 120b of sampling device 120 is inserted. Socket 122a is mounted underneath and adjacent to contact image sensor 122b such as the LIS-1024 type sensor manufactured by Panavision SVI (Horner, New-York).

Analyzing unit 122 is housed in housing tube 124, and housing tube 124 is mounted underneath dashboard 402 of the car (see FIG. 5).

FIG. 2b illustrates a magnified-view of sampling device 120 and analyzing unit 122. As seen in the figure, a line 128 is formed across reagent pad 120c and about midway lengthwise when in contact with saliva in which the alcohol level is greater than a predetermined threshold value (when the level of alcohol in the saliva is less than the threshold, no line appears on the reagent pad). It should be noted that sampling device 120 can be configured so that the threshold value of the alcohol concentration in the saliva meets with different local regulations.

To capture and record the image of line 128, contact image sensor 122b is mounted on top of socket 122a in such a way that imaging active region 126 (about 8 mm in length) of contact image sensor 122b is positioned on top of the reactive area of reagent pad 120c (i.e., the area at which line 128 forms).

The sobriety test begins by pulling sampling device 120 from analyzing unit 122 and inserting reagent pad 120c into the mouth. Reagent pad 120c has to be kept in the mouth for several minutes during which line 128 is produced if in contact with saliva alcohol greater than the threshold value.

Reagent pad 120c is then inserted into socket 122a for analyzing the saliva sample, and contact image sensor 122b captures and records an image of reagent pad 120c.

As noted earlier, face recognition system 115 is integrated with saliva analyzer sobriety interlock device 100 to insure that the driver is a person allowed to operate the vehicle. Video camera 119 (see FIG. 4) captures the face of the driver continuously during the sobriety test i.e., from the moment the driver pulls sampling device 120 (or 302) from analyzing unit 122 until the moment at which output unit 112 displays the sobriety test results.

The facial images are stored in PC 117 and compared against stored images of persons allowed to operate the automobile. If the captured images do not match at least one of the stored images, saliva analyzer sobriety interlock device 100 prevents operation of the automobile. However, if at least one of the captured images matches one of the stored images, operating the automobile will depend only on the sobriety test results.

It should be mentioned that integrating face recognition system 115 with saliva analyzer sobriety interlock device 100 provides additional security against theft.

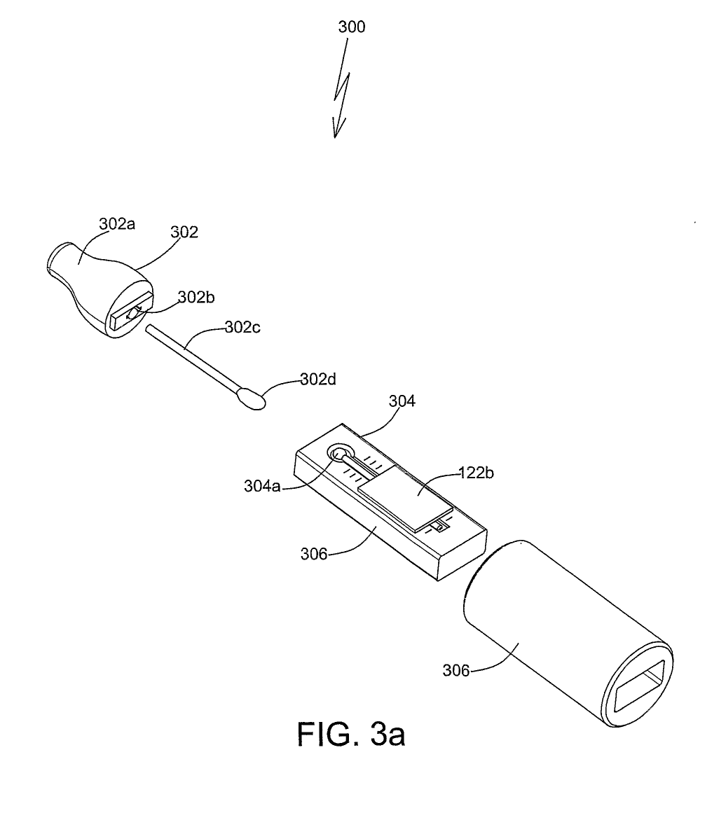

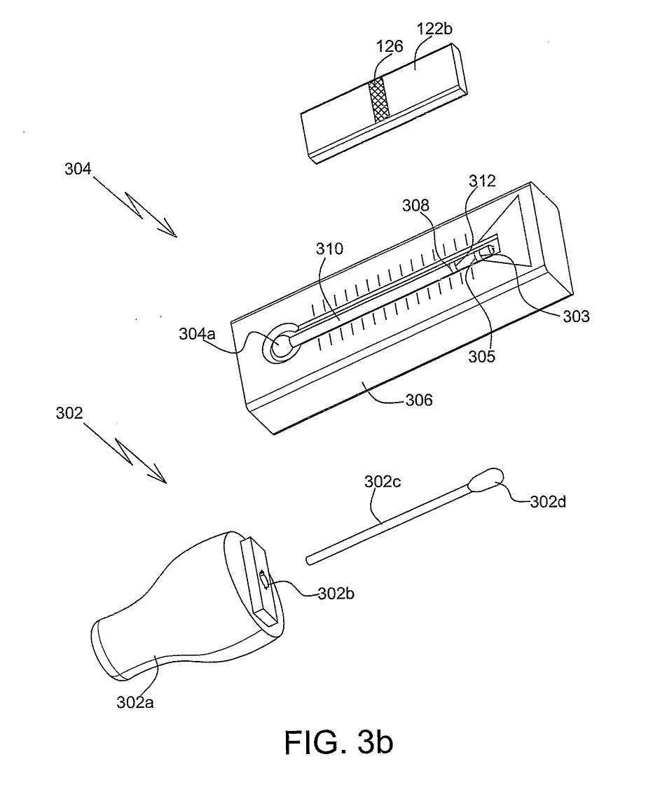

FIG. 3a illustrates an alternative testing unit 300 that can be used in a saliva analyzer sobriety interlock device 100. As seen, testing unit 300 comprises sampling device 302, analyzing unit 304, and housing tube 306.

In the alternative embodiment, interlock device 100 employs a Q.E.D. (A150 or A350) sobriety test, manufactured by Pointofcare.net (Charlottesville, Va.), for measuring the alcohol level in the saliva.

The Q.E.D. test is based on the methodology of alcohol dehydrogenase. It is an easy to operate test that provides quantitative results as accurate as the results obtained by a blood test in approximately two to five minutes.

Sampling device 302 comprises a handle 302a to be grasped by one hand of the user. Handle 302a is formed with a socket 302b into which there is inserted a disposable stick 302c with absorbing swab 302d on its distal end.

Analyzing unit 304 comprises Q.E.D. socket 306 mounted underneath and adjacent to contact image sensor 122b. Analyzing unit 304 is housed in housing tube 306, which is mounted underneath dashboard 402 of the car (see FIG. 5).

FIG. 3b illustrates a magnified-view of sampling device 302 and analyzing unit 304. As seen, fluid level 303 passes QA Spot™ 305, and a distinct purple bar 308 is formed within the marked scale region 310 if the saliva sample contains alcohol molecules in it. The highest point 312 of the purple bar represents the level of alcohol in the saliva sample.

Contact image sensor 122b is positioned on top of socket 306 in such a way that the sensor's imaging active area 126 is right on top of the area in which purple bar 308 forms.

When using the Q.E.D. test, absorbing swab 302d is inserted into the mouth for collecting saliva. Absorbing swab 302d is kept in the mouth for 30-60 seconds or until it is completely saturated with saliva. Then, absorbing swab 302d is inserted into the entry port 304a of Q.E.D. testing socket 306 and pressed steadily to activate a capillary action as a result of which the fluid rises until it passes the QA Spot™ 305. Purple bar 308 forms within the marked scale region 310 after approximately two minutes and is captured and recorded by contact image sensor 122b,

According to both embodiments of the present invention, the image detected by contact image sensor 122b is then transferred to an analog to digital converter, which encodes the image as digital data and supplies digitized values of alcohol level to a digital logic processor 106. Digital logic processor 106 receives the alcohol level digital value and compares it to a threshold value stored a priori internally. If the alcohol level is lower than the threshold value, the driver passes the sobriety test. However, if the alcohol level is higher than the threshold value, the driver fails the sobriety test.

In parallel to the sobriety test, face recognition system 115 provides digital logic processor 106 with I/O input based on the face recognition test (i.e., “pass” or “failed”). If the driver passes both the sobriety test and the face recognition test successfully, digital logic processor 106 enables ignition system controller 108, which in turn enables ignition system 110. However, if the driver fails either of the tests, digital logic processor 106 disables ignition system controller 108, which in turn disables ignition system 110. Test results are displayed on output unit 112 (i.e., a graphic user interface—GUI controller).

In case that additional information and/or messages are to be displayed for the driver, output unit 112 may include a small LCD (Liquid Crystal Display) screen.

It will be understood that saliva analyzer sobriety interlock device 100 is designed in such a way that it can be used with other security immobilizing devices. More specifically, ignition system controller 108 of saliva analyzer sobriety interlock device 100 can be connected to additional immobilizing devices. Thus, whether ignition system controller 108 is enabled or not depends on the signals obtained from each and every device.

FIG. 4 is a perspective view of vehicle interior 400. Vehicle interior 400 in a passenger automobile, typically includes conventional dashboard 402 and steering wheel 404. In accordance with a preferred embodiment of the present invention, vehicle interior 400 is equipped with saliva analyzer sobriety interlock device 100 part of which is mounted underneath the dash board 402.

As seen in the figure, aperture 406 is an inlet opening through which flat medium 120b of sampling device 120 is inserted into analyzing unit 122 which is housed in housing tube 124 mounted underneath dashboard 402 (see FIG. 5). Output unit 112 (GUI controller) is situated on dashboard 402 next to aperture 406, and camera 119 of face recognition system 115 is attached to sun visor 123.

It should be mentioned that a GUI controller of any type could be used as an output unit 112 in the saliva analyzer sobriety interlock device 100. However, the GUI controller, in accordance with a preferred embodiment of the present invention, comprises a single light-emitting diode (LED) with three colors as yellow, green and red. While saliva analyzer sobriety interlock device 100 is not in use, the yellow light flashes. During the test, the red light flashes, and when the test is complete, and driving is allowed, the green light is on for one minute followed by a flashing yellow light. When driving is prohibited, the red light is on for one minute and then the yellow light flashes. When saliva analyzer sobriety interlock device 100 is out of order, the yellow light is on steadily.

FIG. 5 is a side view of vehicle interior 400. The figure illustrates housing tube 124 of testing unit 200 mounted underneath dashboard 402. The figure also illustrates PC 117 of face recognition system 115 and sealed box 107, which contains power supply 113 and processing unit 109 mounted underneath dashboard 402.

It will be understood that the locations of the various components of saliva analyzer sobriety interlock device 100 are only suggestive; the various components of device 100 can be suitably positioned anywhere else in the car.

It should be noted that saliva analyzer sobriety interlock device 100 is not restricted to alcohol measurements but can be modified to suit drug tests as well. This can be done by replacing the testing units described above by a testing unit adequate for drug measurements and by updating the threshold values stored in digital logic processor 106.

It should also be noted that the inventive saliva analyzer sobriety interlock device is not restricted to automobiles but can be implemented in airplanes, ships, sea-crafts, armored vehicles heavy machines and so on.

Having described the invention with regard to certain specific embodiments thereof, it is to be understood that the description is not meant as a limitation, as further modifications will now become apparent to those skilled in the art, and it is intended to cover such modifications as fall within the scope of the appended claims.

1. A sobriety interlock device for measuring the alcohol concentration in a driver's saliva sample and prohibiting ignition of a vehicle when the driver is intoxicated, said device comprising:
a testing unit into which a saliva sample of the driver is insertable for testing and recording the alcohol concentration in said saliva sample, said testing unit comprising an image sensor for capturing and recording an image indicating the alcohol concentration in said saliva sample;
a processing unit which said image is to be transferred, said processing unit comparing said alcohol concentration to a threshold value stored a priori internally and providing sobriety test results;
and
an ignition system controller responsive to said sobriety test results to enable or disable the vehicle ignition system depending on whether the sobriety test is passed or failed respectively.

2. The sobriety interlock device of claim 1, further comprising an output unit for displaying said test results and for providing instructions and messages.

3. The sobriety interlock device of claim 1, wherein said testing unit comprises a sampling device, an analyzing unit and a housing tube.

4. The sobriety interlock device of claim 3, wherein said sampling device comprises a handle having a flat medium extending therefrom on top of which a reagent pad is placed.

5. The sobriety interlock device of claim 3, wherein said sampling device comprises a handle having a stick extending therefrom with an absorbing swab attached to the distal end of said stick.

6. The sobriety interlock device of claim 3, wherein said analyzing unit comprises:
a socket with a transparent portion into which said sampling device is inserted; and
a contact image sensor positioned above said transparent portion for capturing and recording images.

7. (canceled)

8. (canceled)

9. The sobriety interlock device of claim 3, wherein said analyzing unit is housed in said housing tube.

10. The sobriety interlock device of claim 1, further comprising an integrated face recognition system that determines if said driver is a person allowed to operate the vehicle.

11. The sobriety interlock device of claim 10, wherein said face recognition system captures images of the face of the driver continuously from the moment said measuring method begins and until completed and compares said images to stored images of persons allowed to operate the vehicle.

12. The sobriety interlock device of claim 1, wherein said processing unit enables said vehicle ignition system if said alcohol concentration is lower than a predetermined alcohol concentration threshold and if said face recognition system determines that said driver is a person allowed to operate said automobile.

13. The sobriety interlock device of claim 1, wherein said processing unit disables said vehicle ignition system either if said alcohol concentration is higher than a predetermined alcohol concentration threshold or said face recognition system determines that said driver is not a person allowed to operate said vehicle.

14. The sobriety interlock device of claim 12, wherein said output unit displays said test results.

15. A method for measuring the alcohol concentration in a driver's saliva sample and prohibiting ignition of a vehicle when the driver is intoxicated, said method comprising:
inserting a sampling device with a testing medium into a driver's mouth for a predetermined time to collect saliva;
inserting said sampling device with said saliva sample into a testing unit for testing and recording the alcohol concentration in said saliva sample,
said testing unit comprising an image sensor for capturing and recording an image indicating the alcohol concentration in said saliva sample;
transferring said image to a processing unit for comparing said alcohol concentration to a threshold value stored a priori internally and for providing sobriety test results;
and
controlling an ignition system controller by said sobriety test results and enabling or disabling a vehicle ignition system depending on whether the sobriety test is passed or failed.

16. The method of claim 15, further comprising the step of displaying said sobriety test results and providing instructions and messages via an output unit.

17. The method of claim 15, wherein said testing medium comprises a reagent pad.

18. The method of claim 15, wherein said testing medium comprises a stick with an absorbing swab.

19. (canceled)

20. The method of claim 15, further comprising the step of providing a face recognition system for determining if said driver is a person allowed to operate the vehicle.

21. The method of claim 20, wherein said determining step further comprises the steps of:
capturing images of the face of the driver continuously from the moment said measuring method begins and until completed; and
comparing said images to stored images of persons allowed to operate the vehicle.

22. The method of claim 21, wherein said controlling step comprises enabling said vehicle ignition system if said alcohol concentration is lower than a predetermined alcohol concentration threshold and if said face recognition system determines that said driver is a person allowed to operate said vehicle.

23. The method of claim 21, wherein said controlling step comprises disabling said vehicle ignition system either if said alcohol concentration is higher than a predetermined alcohol concentration threshold or said face recognition system determines that said driver is not allowed to operate said vehicle.
